(19) United States
(12) Patent Application Publication
(10) Pub. No.: US 2024/0275940 A1
(43) Pub. Date: Aug. 15, 2024

(54) HEAD-MOUNTED DISPLAYS COMPRISING A CYCLOPEAN-EYE SENSOR SYSTEM

(71) Applicant: Microsoft Technology Licensing, LLC, Redmond, WA (US)

(72) Inventor: Harpreet Singh SAWHNEY, Kirkland, WA (US)

(73) Assignee: Microsoft Technology Licensing, LLC, Redmond, WA (US)

(21) Appl. No.: 18/167,552

(22) Filed: Feb. 10, 2023

(51) Int. Cl. H04N 13/398; G02B 27/01; G06F 3/01; G06T 3/00; G06T 7/593

(52) U.S. Cl. CPC H04N 13/398; G02B 27/0172; G06F 3/011; G06T 3/18; G06T 7/593

(57) ABSTRACT

Examples are disclosed related to head-mounted displays implementing a cyclopean-eye sensor system. One example includes a head-mounted display comprising a cyclopean-eye sensor system. The head-mounted display further comprises a processor and memory storing instructions that, when executed by the processor, cause the processor to receive depth data and image data from the cyclopean-eye sensor system and to render first and second images using the depth data and the image data, wherein the first image, the second image, and the image data depict different angular views of a scene.

### BACKGROUND

Near-eye display (NED) technology can be used to create and project a virtual image in the field-of-view (FoV) of one or both eyes of a user. Such technology may be incorporated into wearable displays, such as head-mounted displays (HMIDs). HMDs can be implemented in the form of different devices. Common implementations include helmet-mounted displays, eyeglasses, visors, and other eyewear. A near-eye display presents virtual images to the eye, enabling applications in virtual reality (VR) and augmented reality (AR). AR/VR devices and related experiences augment the physical world, either within the user's own physical environment or in a virtualized environment with information and three-dimensional (3D) objects to assist and force-multiply tasks.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed related to head-mounted displays implementing a cyclopean-eye sensor system. One example includes a head-mounted display comprising a cyclopean-eye sensor system. The head-mounted display further comprises a processor and memory storing instructions that, when executed by the processor, cause the processor to receive depth data and image data from the cyclopean-eye sensor system and to render first and second images using the depth data and the image data, wherein the first image, the second image, and the image data depict different angular views of a scene.

### BRIEF DESCRIPTION OF THE DRAWINGS

FIG. 1 shows an example head-mounted display implementing a cyclopean-eye sensor system.

FIG. 2 shows an example headset implementing a cyclopean-eye sensor system.

FIG. 3 shows the conceptual idea of a cyclopean eye.

FIG. 4 schematically shows an example binocular rendering process using co-located RGB and depth images acquired by a cyclopean-eye sensor system.

FIG. 5 shows a flow diagram of an example method for rendering binocular views using a cyclopean-eye sensor system.

FIG. 6 schematically shows an example of a computing system that can enact one or more of the methods and processes described above.

### DETAILED DESCRIPTION

Current AR/VR devices utilize distributed sensors for various applications, including optical/video pass-through, head tracking, and depth sensing. The distributed nature of the sensors, although intuitive and straightforward to implement, introduces several issues. Such problems can include unreliable calibration, inherent inaccuracies of stereo three-dimensional (3D) computations, and difficulty in achieving accurate and repeatable dense depth map computations.

Unreliable calibration among the distributed sensors can translate to various complications. One source of inaccurate calibration among distributed sensors includes the non-complete rigidity of frames implemented in AR/VR devices. Bends and distortions that the frame of the AR/VR device endures during usage in industry, home, and work settings can result in physical displacement of the sensors relative to one another over time. As such, even if factory calibration is accurate, within the realities of physical impact, such as bending, distortions, and temperature variations, the calibration parameters can lead to large errors in 3D measurements. Even with field calibration algorithms, the performance is far from the typical accuracy requirements for industrial and enterprise applications.

One complication resulting from calibration errors include inaccurate computations. For example, in optical and video pass-through modes for AR/VR applications, current devices typically implement binocular or multi-ocular visual sensing with two or more cameras distributed across the device. The distributed sensors can create 3D measurements in the environment via stereo computations. However, calibration errors between cameras can lead to incorrect stereo reconstruction. For example, the toe-in/toe-out type of deformation resulting from non-rigidity of HMID frames can have an effect on errors in binocular depth computations. Errors in depth vary proportionally to the square of the depth of a point. Further, the deformations can introduce a scaling-type error in depth.

With distributed sensors, the signal distribution and multi-signal/multi-modal processing of signals is a complex issue. For example, in some current devices containing visible light sensors and depth sensors, head tracking computations generally utilize data from the visible light cameras, and may not take advantage of data from the depth sensors. Furthermore, in some cases, similar computations are performed multiple times by the different sensors. For example, depth sensing and processing can be performed multiple times in many applications, including passive binocular stereo processing for computing 3D features for self-localization and mapping (SLAM) and head tracking (HeT), and time-of-flight (ToF) depth processing for scene and object understanding. These redundancies and inefficiencies of multiple sensors performing similar computations make it more difficult to meet size, weight, and power (SWaP) constraints. These and the issues described above reduce the scope of multi-sensor AR/VR devices to workflows in small, restricted volumes of space and to applications that do not have high accuracy requirements.

In view of the observations above, aspects of head-mounted displays implementing a cyclopean-eye sensor system and related rendering techniques are provided. The term “cyclopean eye” refers to a logical concept that explains a unified perception of the world with a physical aspect by transforming the classic binocular vision into one that is monocular, displacing the two eyes with a cyclopean eye. For head-mounted displays, such an aspect can be implemented with a single cyclopean-eye sensor system that can sense both depth and light intensity per pixel. Left and right binocular images can then be synthesized and rendered in software based upon the cyclopean-placed sensor system.

A cyclopean-eye sensor system can be implemented in various ways. Some aspects include head-mounted displays designed with a multi-modal cyclopean-eye sensor system that includes one or more sensors capable of providing multi-modal data signals. In some implementations, the multi-modal cyclopean-eye sensor system includes at least two different types of sensors located proximate to one another. The multi-modal cyclopean-eye sensor system can be used to synthesize binocular views for display to both the user's eyes for various applications, including AR/VR. In previous HMD designs, this is typically performed by dual cameras located on either side of a user's temples, emulating the perspectives of the user's eyes. Additionally, the multi-modal cyclopean-eye sensor system can be used to perform runtime computations for various applications, including but not limited to head tracking, hand tracking, eye tracking, scene/environment understanding (SU/EU), and object understanding (OU).

The cyclopean-eye sensor system can mitigate many shortcomings found in HMDs utilizing distributed sensors. These deficiencies include but are not limited to inaccurate calibration, complex computations, and inefficient computational redundancies. The cyclopean-eye design simplifies the hardware of the HMDs and expands the application scope of such devices to high accuracy, large work volume, and flexible SWaP utilization. For example, current AR/VR devices tend to rely on passive visual sensors in lieu of ToF sensors to reduce the devices' SWaP utilization. However, such implementations can lead to unreliable and inaccurate performance in low light settings, including common indoor environments that tend to have many textureless surfaces. By implementing a single localized cyclopean-eye sensor system instead of multiple distributed sensors, SWaP constraints are easier to achieve.

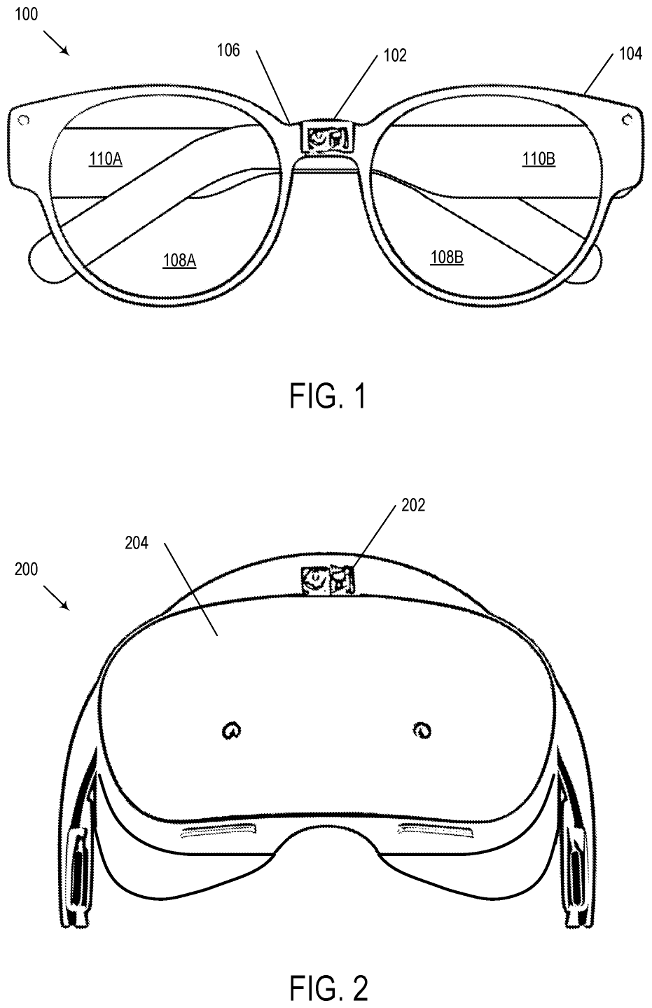

Referring now to FIG. 1, an example head-mounted display 100 implementing a cyclopean-eye sensor system is illustrated. In the depicted example, the head-mounted display 100 is in the form of eyeglasses. The head-mounted display 100 includes a cyclopean-eye sensor system 102 mounted on a frame 104 proximate a bridge 106 of the eyeglasses head-mounted display 100. The cyclopean-eye sensor system 102 includes one or more sensors of different sensing modes, hereinafter referred to as multi-modal sensor(s). For example, the multi-modal sensor(s) can be implemented as a single physical sensor capable of more than one sensing modes. The multi-modal sensor(s) can also be implemented as two or more sensors, each capable of a different sensing mode. In some implementations, the cyclopean-eye sensor system 102 includes a depth sensor (such as ToF sensors) and a visible sensor (such as cameras operating in red, green, and blue (RGB) wavelengths). The cyclopean-eye sensor system 102 can include additional sensors depending on the application. Example sensors include accelerometers, gyroscopes, magnetometers, and inertial measurement units (IMUs).

The multi-modal sensor(s) can be implemented as a single physical sensor capable of sensing multi-modal data. For example, a depth sensor and a visible light sensor may physically be a single sensor with a common focal plane on which, using filtering and processing, both the visible light spectrum and the IR spectrum typically used by depth sensors are sensed. The multi-modal sensor(s) can also be implemented as a plurality of physically separate sensors. For example, the cyclopean-eye sensor system 102 can include two physically different sensors implemented in a sensor package where the two sensors are disposed in proximity to one another.

The head-mounted display 100 can further include a controller. The controller can include, among other components, a logic subsystem and a storage subsystem that stores instructions executable by the logic subsystem to control the various functions of head-mounted display 100, including but not limited to the control of the cyclopean-eye sensor system 102 and its multi-modal sensor(s).

The multi-modal sensor(s) in the cyclopean-eye sensor system 102 can be arranged and implemented in various ways. For example, the multi-modal sensor(s) can be integrated within a compact package. In some implementations, at least two of the multimodal sensors are co-located. Co-located sensors can be arranged in various ways. Co-located sensors can be implemented as a single device with multiple sensing mode capabilities or as separate devices in proximity to one another in a single sensor package. For example, a ToF sensor and an RGB sensor can be implemented to create a co-located sensing module with visible and depth capabilities. In some implementations, the centers of the co-located sensors are within two centimeters of one another. In further implementations, the centers of the co-located sensors are within one centimeter of one another. Alternatively or additionally, the co-located sensors can share a common focal point and a focal plane. For example, co-located sensors can be implemented on a single physical device that can sense both the visible light spectrum (for image data) and the infrared spectrum (for depth data) using various filtering and processing techniques. The co-located sensors can be converged such that they share the same or substantially the same FoV. The term “substantially the same” represents sufficient proximity for left and right views to be synthesized from data sensed by the co-located sensors.

The head-mounted display 100 includes a first lens system 108A and a second lens system 108B supported by the frame 104, and the frame 104 is connected to a first temple arm 110A and a second temple arm 110B. The term “lens” is used herein to represent one or more optical components through which a real-world environment can be viewed. The first lens system 108A and the second lens system 108B each can be designed as an optical combiner that combines virtual and real imagery. Further, each lens system optionally can include optical components other than a combiner, such as a separate optical component with or without optical power. The head-mounted display 100 can include one or more projectors for projecting image light. The first and second lens systems 108A, 108B can be utilized to redirect the projected image light towards the user's eyes. For example, one or both of the first and second lens systems 108 can include a waveguide for guiding and redirecting light from a projector.

Head-mounted displays implementing a cyclopean-eye sensor system can be of various forms and styles. FIG. 100 illustrates eyeglasses implementing a cyclopean-eye sensor system that can be implemented as smart eyeglasses for various AR/MR applications. Other forms include visors, goggles, helmet-mounted displays, monocular displays, and various other eyewear. FIG. 2 illustrates an example headset 200 implementing a cyclopean-eye sensor system. The headset 200 is implemented as a head-mounted display containing a cyclopean-eye sensor system 202 located at the center above a front cover 204. Internally, the headset 200 includes one or more displays, such as a liquid crystal display (LCD), that provide images for viewing by the user. Such devices can be implemented for various VR applications.

A cyclopean-eye sensor system mounted on an HMD can provide various functionalities for AR/VR applications. Implementing a multi-modal sensor or multiple sensors in proximity to one another can mitigate several disadvantages found in HMDs utilizing distributed sensors. Advantages of cyclopean-eye-based HMDs over devices with distributed sensors include simpler calibration parameters and reduction in computational redundancies by utilizing complementary data signals across multi-modal sensor(s). For example, runtime computations for various applications can be performed using multi-modal data from the cyclopean-eye sensor system. In some implementations, multi-modal data from the cyclopean-eye sensor system is transmitted to a remote device that performs the runtime computations. Further, cyclopean-eye sensor systems can be implemented to provide binocular display rendering. Previously, this is performed using at least two distributed RGB cameras. Cyclopean-eye sensor systems can perform such renderings using a visible light sensor and a depth sensor. Data from these sensors can be used to synthesize images of different angular views, such as views from the left and right eyes, to implement binocular display rendering.

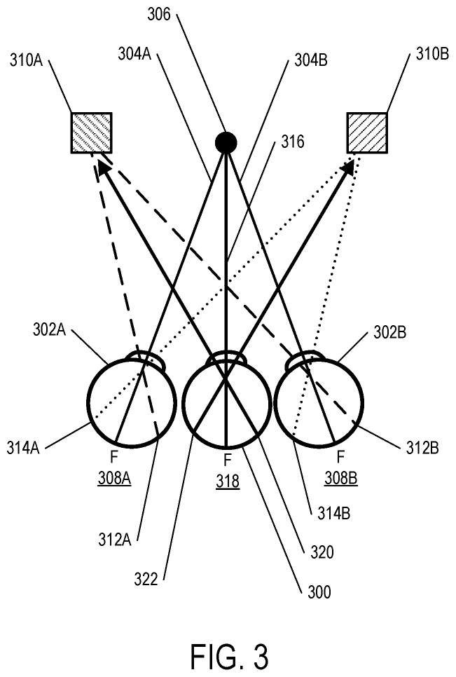

The concept of a cyclopean eye can be traced back to a biological idea that the directions derived from the eyes of an observer can be perceived as if that observer is viewing the scene from a single vantage point between the observer's eyes. Although a person's anatomical eyes operate with binocular vision, the brain sees a single image. FIG. 3 illustrates the conceptual idea of a cyclopean-eye 300. As shown, the cyclopean-eye 300 is located between a left eye 302A and a right eye 302B. The principle visual directions of the two eyes 302A, 304B are shown by lines 304A, 304B linking a fixation point 306 to the foveae 308A, 308B of the eyes 302A, 304B. Light from a first object 310A and a second object 310B (such as reflected visible light) stimulates different retinal points in the left and right eyes 302A, 302B. Each retinal point in a person's eye has a corresponding retinal point in the other eye, with the pair referred to as “corresponding points.” Other pairs of retinal points are referred to as “disparate points.”

Light from an object can stimulate a retinal point in each eye. The information is transmitted to the brain, and a single visual image localized in the same spatial direction is created. However, if disparate retinal points are stimulated, double vision can occur. In the illustrative concept, the first object 310A stimulates the nasal retinal point 312A of the left eye and the temporal retinal point 312B of the right eye. These two retinal points 312A, 312B are corresponding points. Similarly, the second object 310B stimulates the temporal retinal point 314A of the left eye and the nasal retinal point 314B of the right eye. These two retinal points 314A, 314B are corresponding points. The observations above enable the cyclopean-eye 300 to derive similar information as the two eyes 302A, 304B. A line 316 in the principle visual direction of the cyclopean-eye 300 links the fixation point 306 with the fovea 318 of the cyclopean-eye 300. Corresponding points 312A, 312B are reduced to retinal point 320, and corresponding points 312A, 312B are reduced to retinal point 322. From this, the spatial locations of the two objects 310A, 310B can be determined.

The cyclopean-eye concept can be adapted to designs for HMDs, implemented as a multi-modal cyclopean-eye sensor system. In some implementations, the multi-modal cyclopean-eye sensor system is utilized to synthesize binocular information for various applications, such as binocular rendering in AR/VR applications. Furthermore, implementation of a multi-modal cyclopean-eye sensor system can simplify and make robust computer vision runtimes for such applications.

In VR applications, micro-display panels (e.g., a liquid crystal on silicon (LCoS) micro-display) or scanning beam displays, as examples, can be implemented to render a full scene for the user's eyes with suitable projector optics. In pass-through mode, two RGB cameras are typically implemented to capture the current scene, which can then be rendered for the user to view through the displays. Low latency rendering can be performed by lightweight processing of the raw RGB camera signals to render the scene from the vantage point of the user's eyes to provide a binocular viewing experience. The two cameras are typically implemented in proximity to the user's eyes, respectively, to minimize the parallax effects of pass-through rendering. Inter pupillary distance (IPD) can be used to physically adjust the two displays such that the user's eyes and the brain fuse the binocular stimuli to create a coherent perception of a 3D scene. Wide FoV RGB cameras can be used to provide a user with foveal and peripheral inputs, providing a more comfortable and accurate viewing experience as the only visual input the user receives is through the cameras—i.e., the user cannot see the physical scene directly.

The cyclopean-eye sensor system enables pass-through rendering without the use of two physical high-resolution RGB cameras. In some implementations, the cyclopean-eye sensor system includes a visible sensor and a depth sensor. Example visible sensors include various passive visible cameras. In some implementations, the visible sensor is a high-resolution RGB camera. Implemented as part of the cyclopean-eye sensor system, the high-resolution RGB camera and the depth sensor can be co-located. Example depth sensors include ToF sensors, including indirect time-of-flight (iToF) cameras and direct time-of-flight (dToF) cameras. A dToF camera measures actual round-trip times at each pixel for light projected from the camera to be received by the pixel. An iToF camera uses a phase difference in a projected amplitude-modulated light (e.g., infrared light) signal compared to a received reflected signal to determine distance at each pixel. Other examples of depth sensors include structured light cameras that determine depth values per pixel by imaging a scene while projecting a pattern of light into the scene, and computing depth values for each image pixel based upon distortions in the pattern as imaged caused by objects in the scene.

In some implementations, the high-resolution RGB camera is co-located with a ToF sensor. In further implementations, the sensors are converged. The co-located RGB information and depth information that are observed can be used to render in software and/or hardware the left and right eye images on two displays as if the two eyes are viewing the physical scene directly.

For optical see-through AR, the displays are generally implemented using waveguides and a projector system. Example projector systems include microelectromechanical (MEMS) lasers and LCoS technology. Added AR content, such as computer-generated 3D objects, can be rendered for the user's two eyes. The content can be rendered with its various parameters, such as position, orientation, pose and dynamics, determined with respect to information observed by the depth sensor in the cyclopean-eye sensor system. For example, the scene depth and semantics observed by the depth sensor can be used to render the AR content separately for the left and right eyes. Unlike pass-through VR, the AR content, the scene is directly visible to the user and does not need to be rendered.

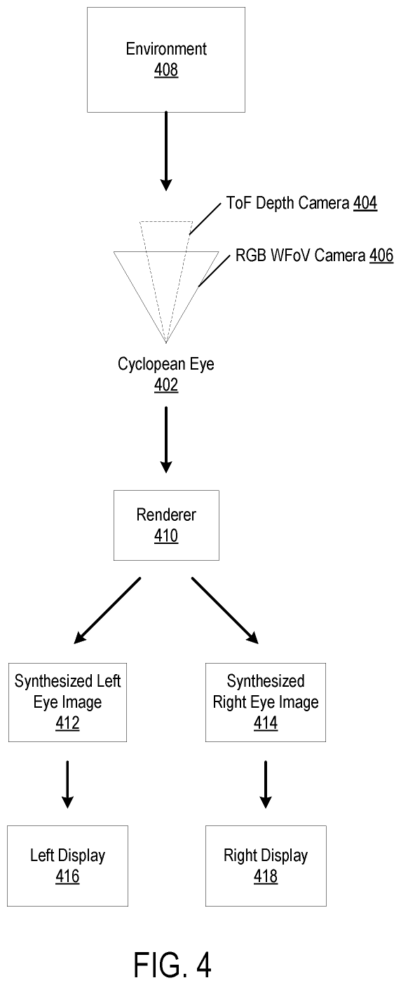

With the visible sensor and the depth sensor co-located, the depth per pixel and RGB values per pixel can be aligned. Along with known baseline parameters such as IPD and distances between the sensors in the cyclopean-eye sensor system and the virtual eye cameras, rendering of the left and right views can be performed. In some implementations, backward and/or forward warping/rendering is utilized to render the left and right views. For example, pixels from the image data can be mapped to different points based on information from the depth data to synthesize images corresponding to the left and right views. FIG. 4 schematically illustrates an example binocular rendering process 400 using co-located RGB and depth images acquired by a cyclopean-eye sensor system 402. The cyclopean-eye sensor system 402 can be implemented in various ways. In the depicted example, the cyclopean-eye sensor system 402 includes a ToF depth camera 404 and an RGB wide FoV camera 406. The ToF depth camera 404 and RGB wide FoV camera 406 can be co-located within a predetermined distance. In some implementations, the ToF depth camera 404 and the RGB wide FoV camera 406 are located within a predetermined distance of two centimeters of each other. In further implementations, the ToF depth camera 404 and the RGB wide FoV camera 406 are located within a predetermined distance of one centimeter of each other. The predetermined distance can be of any length. In some implementations, the ToF depth camera 404 and the RGB wide FoV camera 406 are converged such that they share the same or substantially same FoV. Depending on the application, the cyclopean-eye sensor system 402 can include additional sensors, such as accelerometers, gyroscopes, magnetometers, IMUs.

Different types of ToF depth cameras can be implemented. In some implementations, the ToF depth camera 404 is a dToF camera. In further implementations, the ToF depth camera 404 is a dToF LiDAR module with on-chip processing. Different data buffer lengths can be implemented. For example, the dToF camera can be implemented with a 1 k buffer. Other depth sensors such as iToF cameras structured light cameras can also be implemented. The ToF depth camera 404 can be designed to operate at different wavelengths and different ranges. In some implementations, the ToF depth camera 404 operates at a wavelength of approximately 940 nanometers. In some implementations, ToF depth camera 404 can detect distances within a range of approximately 5 centimeters to approximately 5 meters. In other examples, the ToF depth camera 404 can operate at other wavelengths and/or can detect different ranges of distances.

Different camera specifications can be implemented for different applications. For example, sensors with a relatively wider FoV can provide more reliable information compared to relatively narrower FoV sensors for various applications. One such application includes head tracking where relatively wider FoV cameras can be implemented to provide depth features and/or visible features for more reliable computations. Another example includes pass-through VR applications where an RGB wide FoV camera can be advantageous for recording peripheral regions. In some implementations, the RGB wide FoV camera 406 has a field-of-view of at least 120 degrees. In further implementations, RGB wide FoV camera 406 has a field-of-view of at least 140 degrees. On the other hand, high quality depth estimates can be less important in the peripheral regions. As such, the ToF depth camera 404 can be implemented with a smaller field-of-view. In some implementations, the ToF depth camera 404 has a field-of-view of at least 40 degrees. In further implementations, the ToF depth camera 404 has a field-of-view of at least 60 degrees. The field-of-view specifications can also be described in terms of diagonal field-of-views. For example, the ToF depth camera 404 can be designed to have a diagonal field-of-view of at least 60 degrees. The RGB wide FoV camera 406 can be designed to have a diagonal field-of-view of at least 130 degrees.

As the user moves his or her head and eyes, the central foveal region covered by both the depth and RGB cameras can be used to render the foveal scene at a relatively higher target resolution. The peripheral region does not utilize high quality depth estimates much, and as such can be rendered at a relatively lower target resolution in the peripheral display regions as sprites controlled by a nominal sprite depth guided by the depth computed at the periphery of the depth sensing FoV. This model of adaptive resolution rendering also mimics the human eye in which the foveal region is extremely dense with photoreceptors while the peripheral areas contain coarser receptors. The adaptive resolution rendering can also provide a principled mechanism of managing rendering computations while maintaining natural and high-quality experiences with the pass-through displays.

Depth and RGB image data from the environment 408 to be rendered is recorded by the ToF depth camera 404 and the RGB wide FoV camera 406, respectively. The depth and image data can be passed on to a renderer 410 that synthesizes left 412 and right 414 images. Renderer 410 can be implemented as software, hardware, or a combination of both. The left 412 and right 414 images are synthesized to reproduce the views of the user's left and right eyes, respectively. As such, the left 412 and right 414 images and image data can all have different angular views of the same environment scene. Different methods for synthesizing or rendering the images can be applied. In some implementations, the depth and image data is utilized along with baseline parameters to synthesize the left 412 and right 414 images using a class of backward and forward warping techniques.

After the left 412 and right 414 images are synthesized, the images can be presented for display to a user. The left 412 and right 414 images can be displayed using a left display 416 and a right display 418, respectively, of an HMD. In some implementations, the HMD is a VR device, and the left 412 and right 414 images are displayed in a pass-through VR application. In other implementations, left 412 and right 414 images include AR content and are displayed in an optical see-through AR application on an AR device. One or both displays can be at least semi-transparent.

In addition to rendering the left 412 and right 414 images, multi-modal data from the cyclopean-eye sensor system can also be utilized to perform runtime computations for various applications. Examples of such applications include but are not limited to head tracking, hand tracking, eye tracking, scene/environment understanding, and object understanding. In some implementations, the runtime computations are performed on a backend system. For example, the head-mounted display implemented can have networking capabilities, either through a wired or wireless connection. Data from the cyclopean-eye sensor system can be transmitted to a remote device that performs the computations and returns computed results to the head-mounted display system.

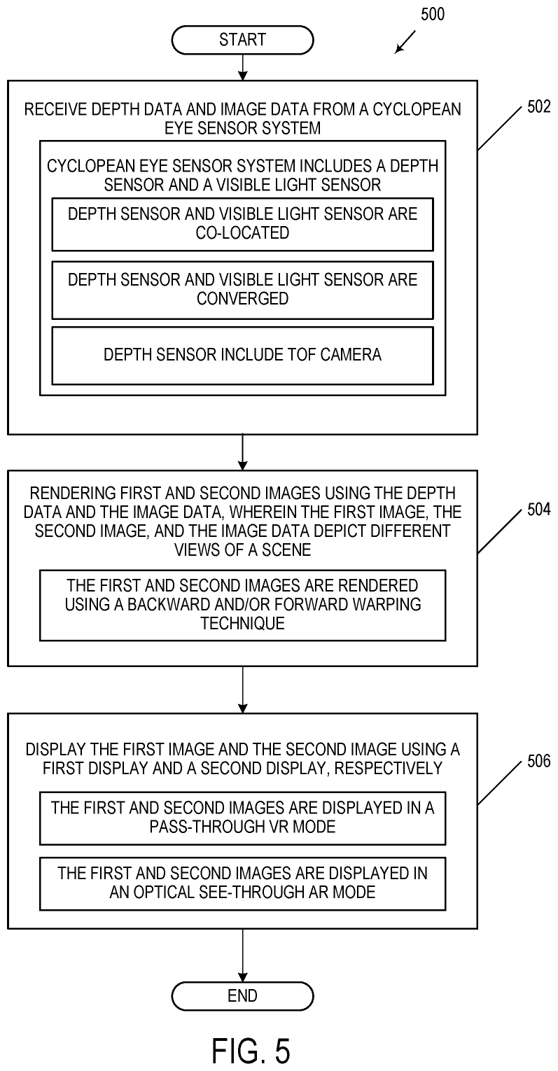

FIG. 5 shows a flow diagram of an example method 500 for rendering binocular views using a cyclopean-eye sensor system. The method 500 includes, at step 502, receiving depth data and image data from a cyclopean-eye sensor system. The cyclopean-eye sensor system can be implemented in various ways. For example, the cyclopean-eye sensor system can be mounted on a head-mounted display device, which can take various forms including eyeglasses, visors, goggles, etc.

The cyclopean-eye sensor system can include one or more sensor(s) to implement a multi-modal sensor system. The sensor(s) can be arranged and implemented in various ways. For example, the sensor(s) can be integrated within a compact package. In some implementations, the multi-modal sensor system is implemented as a single physical sensor capable of more than one sensing mode. For example, a single physical sensor that can sense multi-modal data, such as visible light and infrared light (for depth sensing) can be used. The multi-modal sensor system can also be implemented as two or more sensors, each capable of a different sensing mode. The sensor(s) of the multi-modal sensor system can be co-located. In some implementations, at least two of the sensors are located within a predetermined distance of two centimeters of one another. In some implementations, at least two of the sensors are converged such that they share the same or substantially similar field-of-view.

In some implementations, the cyclopean-eye sensor system includes a depth sensor and a visible light sensor. Depth sensors include but are not limited to ToF depth cameras, which can be classified into iToF and dToF cameras. Other examples of depth sensors include structured light cameras. An example visible light camera includes an RGB camera. The sensors can have different specifications depending on the application. For example, in a pass-through VR application, it can be advantageous for the visible light sensor to have a wide FoV to capture image data from peripheral regions. Depending on the application, the cyclopean-eye sensor system can include additional sensors, such as accelerometers, gyroscopes, magnetometers, IMUs.

At step 504, the method 500 includes rendering first and second images using the depth data and the image data. The images can be rendered in various ways using any of a number of different techniques. The first and second images can be rendered to reproduce the views of the user's left and right eyes, respectively. As such, the first and second images and image data can all have different angular views of the same environment scene. In some implementations, a class of backward and forward warping techniques is utilized to render the images using the image data and the depth data.

At step 506, the method 500 includes displaying the first image using a first display. The second image is displayed using a second display. In some implementations, the displays are part of an HMD, such as the HMD on which the cyclopean-eye sensor system is mounted. In some implementations, the HMD is a VR device and the first and second images are displayed in a pass-through VR application. In other implementations, the first and second images include AR content and are displayed in an optical see-through AR application on an AR device. One or both displays can be at least semi-transparent. The method 500 can be repeated to continually render and display images in real time, enabling various applications such as pass-through VR and optical see-through AR applications.

There are several advantages in using a cyclopean-eye sensor system to synthesize augmented left and right views for AR/VR applications. The aspects of pass-through AR and optical see-through AR in terms of perception and user experience can be carried over to the cyclopean-eye framework. These aspects can be carried over and implemented similarly with less hardware and calibration concerns. Furthermore, implementations of a cyclopean-eye sensor system can include the absence of computations for parallax correction between the left and right displays and the cameras. For example, in HMDs implementing distributed sensors, pass-through VR is implemented using two cameras to capture the scene viewed by the user's eyes, respectively. In such cases, correction is performed for parallax between the displays and their associated camera. With a cyclopean-eye sensor system, the left and right views are correctly synthesized using known IPD and baseline values with respect to a single measured depth and RGB source. Another advantage includes simplified calibration. As the multi-modal sensor(s) are implemented in a cyclopean-eye sensor system, there are no concerns regarding alignment and calibration.

Implementing a cyclopean-eye sensor system for AR/VR applications can help facilitate various computer vision runtimes. These runtimes can be simplified and provide more robustness and reliability with the implementation of a cyclopean-eye sensor system compared to distributed sensing devices. For example, one problem that often occurs in HMDs is the unreliable metric calibration between the distributed cameras used in head tracking applications. The unreliability can be due to non-rigidity of the frames, physical use and abuse of the HMD with drops and dings, and humidity/temperature variations in an environment. Such effects can be more severe in devices aimed to reduce SWaP. For example, devices designed for optimizing SWaP generally result in more flexible frames, less heat dissipation, and inexpensive consumer grade materials. Such qualities can affect calibration and alignment issues for distributed sensors.

Calibration issues can result in variable and largely unacceptable drifts in holograms in medium to large spaces. Even in spaces as small as 5 m×5 m×5 m, variable drift can be observed between the physical landmarks and holograms placed with respect to the landmarks. Drift-free accuracy can be important to user experiences in industry and enterprises. Due to mis-calibration as well as uncertainty of stereo 3D point reconstruction that head tracking uses, keeping misalignment and drift between holographic content and its physical counterpart below 1 centimeter can be difficult. In many cases, such misalignment and drift can vary from 2 centimeters to 100 centimeters.

Calibration issues can also lead to errors in stereo reconstruction of point features that head tracking uses to build a SLAM map of the environment used to self-locate with six degrees of freedom (6DoF). Stereo reconstruction errors have non-linear dependence on mis-calibrated baseline between the stereo cameras and the range of surfaces in the scene. For example, errors in reconstructed depth of 3D points can be proportional to the square of the depth. These effects coupled with visual feature detection and localization errors in low-light scenarios typical of many indoor industrial and home environments can lead to unacceptable and unusable experiences.

Head tracking works by detecting and tracking visual features in one or more cameras, reconstructing corresponding features in the front left and front right eyes using the known calibration, and subsequently using N-point matching of visual features and their reconstructed 3D coordinates for 6DoF pose estimation. Head tracking employs two main building blocks: tracking and mapping. Tracking fuses visual and inertial measurements from on-board cameras and IMUs (gyro, accelerometer, compass) to maintain 6DoF poses over short periods of time. Mapping works in a lazy mode to use visual features and 3D measurements over larger spatial scales. Mapping can also use Bundle Adjustment (BA) to create larger scale-optimized maps. These optimized maps can be fed into the tracking loop to re-locate in visited areas and continuously self-localize and map.

Errors introduced in the tracking loop of head tracking can be hard to mitigate since the mapper typically does not use dense image frames. Instead, the mapper generally works with a sparse collection of frames along with the associated reconstructed maps and visual features computed via the tracker. Even when mapping is moved off the device to an external computing device or the cloud, transmission of dense data all the time may not be feasible. Even though mapping can improve the tracking maps substantially, especially with cloud computing, mitigating all the sources of front-end errors can be challenging.

HMDs implementing a cyclopean-eye sensor system can reduce or eliminate the aforementioned sources of error. For frame-to-frame tracking computations, there is no need to compute stereo triangulations of visual features using the unreliable calibration and error-prone reconstruction. For any computed visual feature, the corresponding depth can be simply read out from the depth frame. Since ToF sensors typically do not suffer from the square-of-depth errors with depth-of-scene features, the errors introduced in the front-end tracker map as sub-linear or linear beyond ranges of about 3-5 meters.

A cyclopean-eye sensor system can be implemented with various multi-modal sensors that are co-located. As such, calibration between the sensors rarely varies. Sensors with convergent fields-of-view implemented in silicon and packaging can further mitigate calibration and non-rigidity issues. In some implementations, the cyclopean-eye sensor system includes a single depth sensor and a single visible light sensor. In such cases, stereo depth is not computed with its associated errors due to calibration, feature extraction, and triangulation as depth is directly available from the depth sensor. This can significantly reduce the demands on the on-device computations since feature matching and stereo triangulation are a substantial part of head tracking. Mapping can be done either on-device or off-device. Mapping can also use reliable 3D estimates derived from the depth sensor. Since errors in these measurements do not vary substantially with depth, Gaussian error models can be more accurate for fusion and global 3D optimization. This can result in creating reliable larger scale maps while minimizing computation.

For information worker, first line worker and home use scenarios, understanding the world in terms of surfaces, objects, and scene entities can be important for situating holographic content for various applications. Reliable reconstruction of surfaces in a room, such as walls, floor, etc., enables understanding boundaries of an environment and placement of AR content such as screens and whiteboards. Computing 3D affordances of objects such as table tops, chairs, and keyboards enables contextual placement of AR avatars and inanimate content for various experiences such as collaborative meetings. Aligning 3D digital twins to their physical counterparts for industrial objects and larger scale environments enables scenarios in which information annotated in databases can be rendered with respect to the real world.

Compared to distributed sensor devices, HMDs implementing a cyclopean-eye sensor system can efficiently and reliably generate a semantic 3D world map with object and surface labels and affordances while maintaining a compact sensor package with manageable SWaP. The cyclopean-eye sensor system facilitates scene and object understanding (world understanding). Direct depth measurements via depth sensors and their alignment and fusion via head tracking enable creation of adaptive resolution 3D point clouds and meshes. Additional sensing is provided via RGB camera with alignment to depth, and semantic labels can be derived via deep networks such as panoptic segmentation and mask region-based convolutional neural networks. Other models can also be used. The expensive computation of dense depth maps via binocular or multi-view stereo (MVS) is not needed. Dense depth computations via stereo can be unreliable since textureless and low-light surfaces can be difficult to reconstruct accurately. Depth sensing mitigates this aspect for textureless, textured, and low-light scenarios. Further, technology for object and surface detection and semantic labeling from 2D visible light cameras can be utilized. Combining the semantic labels with multi-view depth fusion can lead to reliable and repeatable world understanding that enables high quality content placement for a variety of experiences.

As described above, cyclopean-eye sensor systems have SWaP advantages over devices utilizing distributed sensors for display rendering and for computer vision runtimes used to create and manage AR/VR experiences. A cyclopean-eye sensor system can be implemented as a compact sensor package that facilitates localized signal distribution for communications and compute. Hardware implementations for HMDs are also simpler. For example, displays can be easily adapted to any IPD and other types of eye aspects since the provided images are fully synthesized using the cyclopean-eye inputs. With such a system, the HMD can implement pass-through modes without using high resolution cameras for each eye, enabling devices with lower SWaP designs. Co-located multi-modal sensors within a single package reduces or eliminates the problem of variable calibration that has typically existed between distributed sensors. This enables high quality calibration and direct correlation of depth with visual features. Stereo reconstruction is no longer necessary. As such, computer vision runtimes are improved, enabling repeatable and reliable experiences in indoor environments even with textureless surfaces and low light.

In some embodiments, the methods and processes described herein may be tied to a computing system of one or more computing devices. In particular, such methods and processes may be implemented as a computer-application program or service, an application-programming interface (API), a library, and/or other computer-program product.

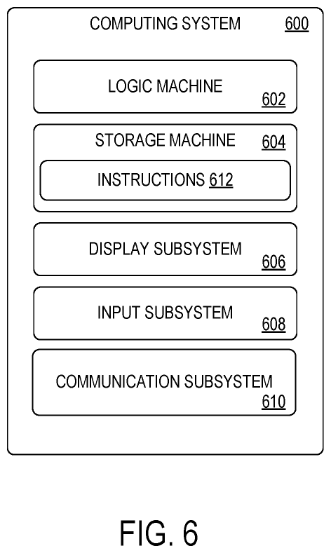

FIG. 6 schematically shows a non-limiting embodiment of a computing system 600 that can enact one or more of the methods and processes described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices.

Computing system 600 includes a logic machine 602 and a storage machine 604. Computing system 600 may optionally include a display subsystem 606, input subsystem 608, communication subsystem 610, and/or other components not shown in FIG. 6. The controller described above with respect to FIG. 1 is an example of computing system 600.

Logic machine 602 includes one or more physical devices configured to execute instructions. For example, the logic machine 602 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 602 may include one or more processors configured to execute software instructions. Additionally or alternatively, the logic machine 602 may include one or more hardware or firmware logic machines configured to execute hardware or firmware instructions. Processors of the logic machine 602 may be single-core or multi-core, and the instructions executed thereon may be configured for sequential, parallel, and/or distributed processing. Individual components of the logic machine 602 optionally may be distributed among two or more separate devices, which may be remotely located and/or configured for coordinated processing. Aspects of the logic machine 602 may be virtualized and executed by remotely accessible, networked computing devices configured in a cloud-computing configuration.

Storage machine 604 includes one or more physical devices configured to hold instructions 612 executable by the logic machine 602 to implement the methods and processes described herein. When such methods and processes are implemented, the state of storage machine 604 may be transformed—e.g., to hold different data.

Storage machine 604 may include removable and/or built-in devices. Storage machine 604 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 604 may include volatile, nonvolatile, dynamic, static, read/write, read-only, random-access, sequential-access, location-addressable, file-addressable, and/or content-addressable devices.

It will be appreciated that storage machine 604 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 602 and storage machine 604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic machine 602 executing instructions held by storage machine 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 606 may be used to present a visual representation of data held by storage machine 604. This visual representation may take the form of a graphical user interface (GUI). As the herein described methods and processes change the data held by the storage machine, and thus transform the state of the storage machine, the state of display subsystem 606 may likewise be transformed to visually represent changes in the underlying data. Display subsystem 606 may include one or more display devices utilizing virtually any type of technology. Such display devices may be combined with logic machine 602 and/or storage machine 604 in a shared enclosure, or such display devices may be peripheral display devices.

When included, input subsystem 608 may comprise or interface with one or more user-input devices such as a keyboard, mouse, touch screen, or game controller. In some embodiments, the input subsystem 608 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 610 may be configured to communicatively couple computing system 600 with one or more other computing devices. Communication subsystem 610 may include wired and/or wireless communication devices compatible with one or more different communication protocols. As non-limiting examples, the communication subsystem 610 may be configured for communication via a wireless telephone network, or a wired or wireless local- or wide-area network. In some embodiments, the communication subsystem 610 may allow computing system 600 to send and/or receive messages to and/or from other devices via a network such as the Internet.

Another aspect includes a head-mounted display comprising a cyclopean-eye sensor system and a processor and memory storing instructions that, when executed by the processor, cause the processor to receive depth data and image data from the cyclopean-eye sensor system and render first and second images using the depth data and the image data, wherein the first image, the second image, and the image data depict different angular views of a scene. In this aspect, additionally or alternatively, the cyclopean-eye sensor system comprises a depth sensor and a visible light sensor. In this aspect, additionally or alternatively, centers of the depth sensor and the visible light sensor are located within two centimeters of each other. In this aspect, additionally or alternatively, the cyclopean-eye sensor system comprises a sensor capable of processing visible light and depth. In this aspect, additionally or alternatively, the head-mounted display further comprises first and second displays, wherein the instructions further cause the processor to display the first image using the first display and display the second image using the second display. In this aspect, additionally or alternatively, the first and second displays are at least semi-transparent and the first and second images comprise augmented-reality content. In this aspect, additionally or alternatively, the cyclopean-eye sensor system comprises a time-of-flight camera. In this aspect, additionally or alternatively, the time-of-flight camera is an indirect time-of-flight camera. In this aspect, additionally or alternatively, the cyclopean-eye sensor system comprises a sensor having a field-of-view of at least 120 degrees. In this aspect, additionally or alternatively, the first and second images are rendered using one or more of backward warping and forward warping.

Another aspect includes a method for displaying stereo-pair images using a cyclopean-eye sensor system, the method comprising receiving depth data and image data from the cyclopean-eye sensor system and rendering first and second images using the depth data and the image data, wherein the first image, the second image, and the image data depict different angular views of a scene. In this aspect, additionally or alternatively, the cyclopean-eye sensor system comprises a depth sensor and a visible light sensor. In this aspect, additionally or alternatively, centers of the depth sensor and the visible light sensor are located within two centimeters of each other on a head-mounted display device. In this aspect, additionally or alternatively, the cyclopean-eye sensor system comprises a sensor capable of processing visible light and depth. In this aspect, additionally or alternatively, the method further comprises displaying the first image using a first display and displaying the second image using a second display.

Another aspect includes a head-mounted display comprising a cyclopean-eye sensor system and a processor and memory storing instructions that, when executed by the processor, cause the processor to provide depth data and image data from the cyclopean-eye sensor system and perform a runtime computation using the depth data and image data. In this aspect, additionally or alternatively, performing the runtime computation comprises transmitting the provided depth data and the image data to a remote device and receiving computed results from the remote device. In this aspect, additionally or alternatively, the runtime computation is performed for an application comprising one or more of head tracking, hand tracking, eye tracking, scene/environment understanding, or object understanding. In this aspect, additionally or alternatively, the instructions, when executed by the processor, further causes the processor to render first and second images using the depth data and the image data, wherein the first image, the second image, and the image data depict different angular views of a scene. In this aspect, additionally or alternatively, the cyclopean-eye sensor system comprises a depth sensor and a visible light sensor.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A head-mounted display comprising:
a cyclopean-eye sensor system; and
a processor and memory storing instructions that, when executed by the processor, cause the processor to:
receive depth data and image data from the cyclopean-eye sensor system; and
render first and second images using the depth data and the image data, wherein the first image, the second image, and the image data depict different angular views of a scene.

2. The head-mounted display of claim 1, wherein the cyclopean-eye sensor system comprises a depth sensor and a visible light sensor.

3. The head-mounted display of claim 2, wherein centers of the depth sensor and the visible light sensor are located within two centimeters of each other.

4. The head-mounted display of claim 1, wherein the cyclopean-eye sensor system comprises a sensor capable of processing visible light and depth.

5. The head-mounted display of claim 1, further comprising first and second displays, wherein the instructions further cause the processor to:
display the first image using the first display; and
display the second image using the second display.

6. The head-mounted display of claim 5, wherein:
the first and second displays are at least semi-transparent; and
the first and second images comprise augmented-reality content.

7. The head-mounted display of claim 1, wherein the cyclopean-eye sensor system comprises a time-of-flight camera.

8. The head-mounted display of claim 6, wherein the time-of-flight camera is an indirect time-of-flight camera.

9. The head-mounted display of claim 8, wherein the cyclopean-eye sensor system comprises a sensor having a field-of-view of at least 120 degrees.

10. The head-mounted display of claim 1, wherein the first and second images are rendered using one or more of backward warping and forward warping.

11. A method for displaying stereo-pair images using a cyclopean-eye sensor system, the method comprising:
receiving depth data and image data from the cyclopean-eye sensor system; and
rendering first and second images using the depth data and the image data, wherein the first image, the second image, and the image data depict different angular views of a scene.

12. The method of claim 11, wherein the cyclopean-eye sensor system comprises a depth sensor and a visible light sensor.

13. The method of claim 12, wherein centers of the depth sensor and the visible light sensor are located within two centimeters of each other on a head-mounted display device.

14. The method of claim 11, wherein the cyclopean-eye sensor system comprises a sensor capable of processing visible light and depth.

15. The method of claim 11, further comprising:
displaying the first image using a first display; and
displaying the second image using a second display.

16. A head-mounted display comprising:
a cyclopean-eye sensor system; and
a processor and memory storing instructions that, when executed by the processor, cause the processor to:
provide depth data and image data from the cyclopean-eye sensor system; and
perform a runtime computation using the depth data and image data.

17. The head-mounted display of claim 16, wherein performing the runtime computation comprises:
transmitting the provided depth data and the image data to a remote device; and
receiving computed results from the remote device.

18. The head-mounted display of claim 16, wherein the runtime computation is performed for an application comprising one or more of head tracking, hand tracking, eye tracking, scene/environment understanding, or object understanding.

19. The head-mounted display of claim 16, wherein the instructions, when executed by the processor, further causes the processor to:
render first and second images using the depth data and the image data, wherein the first image, the second image, and the image data depict different angular views of a scene.

20. The head-mounted display of claim 16, wherein the cyclopean-eye sensor system comprises a depth sensor and a visible light sensor.
